(19) United States
(12) Patent Application Publication
(10) Pub. No.: US 2020/0015062 A1
(43) Pub. Date: Jan. 9, 2020

(54) PUBLIC WARNING MESSAGES USING MBMS

(71) Applicant: Telefonaktiebolaget LM Ericsson (publ), Stockholm (SE)

(72) Inventors: Magnus Tränk, Lerum (SE); Joakim Åkesson, Landvetter (SE)

(21) Appl. No.: 16/490,930

(22) PCT Filed: Mar. 16, 2017
(86) PCT No.: PCT/EP2017/056250

§ 371 Date: Sep. 4, 2019

(51) Int. Cl. H04W 4/90; H04W 4/06; H04W 4/021

(52) U.S. Cl. CPC H04W 4/90; H04W 4/021; H04W 4/06

(57) ABSTRACT

There is provided mechanisms for providing a public warning message using MBMS in a wireless communications system. A method is performed by a control node. The method comprises activating an MBMS bearer to be used for transmission of the public warning message. The method comprises announcing the MBMS bearer in a public warning service announcement to at least one client node over a cellular broadcast channel. The method comprises transmitting the public warning message on the MBMS bearer.

### TECHNICAL FIELD

Embodiments presented herein relate to a method, a control node, a computer program, and a computer program product for providing a public warning message using MBMS in a wireless communications system. Further embodiments presented herein relate to a method, a client node, a computer program, and a computer program product for obtaining a public warning message using MBMS in a wireless communications system. Further embodiments presented herein relate to a method, a client node, a computer program, and a computer program product for obtaining a public warning message in a wireless communications system.

### BACKGROUND

In communications networks, there may be a challenge to obtain good performance and capacity for a given communications protocol, its parameters and the physical environment in which the communications network is deployed.

For example, one parameter in providing good performance and capacity for a given communications protocol in a communications network is the ability to announce and transmit rich warning messages to the public.

Warning notifications are sent to the public to inform about possible emergency situations e.g. severe weather conditions, seismic activities, terror threats, water contaminations. These users may be located at different geographical locations. Broadcast based transmission could efficient when many users are located within the same geographical area.

In general terms, Public Warning Systems (PWS) refer to systems that are configured to broadcast warning notifications to multiple users simultaneously. PWS do not require any acknowledgement of reception of the broadcasted warning notifications.

Current technologies for PWS are based on cell broadcast mechanisms. Short information messages comprising the warning notifications are repeatedly transmitted. In third generation partnership program (3GPP) networks information messages comprising the warning notifications are broadcasted in System Information Blocks (SIBs). The SIBs used for PWS is SIB₁₀ and SIM₁₁.

Legacy PWS system further comprises a network of emergency horns installed on, and in, buildings in urban areas. The emergency horns are used to provide an emergency signal to the public, which is usually used together with additional emergency information provided over traditional FM radio or the Internet.

The current PWS system only provides very short messages, usually broadcasted over a control channel. The main purpose of such a warning notification is that the users should seek further warning messages on other media e.g. traditional FM radio or the Internet. This makes the user dependent on other communication channels.

Hence, there is still a need for an improved distribution of public warning messages.

### SUMMARY

An object of embodiments herein is to provide efficient distribution of public warning messages, and especially such distribution of public warning messages that do not require the user to be dependent on other communication channels.

According to a first aspect there is presented a method for providing a public warning message using MBMS in a wireless communications system. The method is performed by a control node. The method comprises activating an MBMS bearer to be used for transmission of the public warning message. The method comprises announcing the MBMS bearer in a public warning service announcement to at least one client node over a cellular broadcast channel. The method comprises transmitting the public warning message on the MBMS bearer.

According to a second aspect there is presented a control node for providing a public warning message using MBMS in a wireless communications system. The control node comprises processing circuitry. The processing circuitry is configured to cause the control node to activate an MBMS bearer to be used for transmission of the public warning message. The processing circuitry is configured to cause the control node to announce the MBMS bearer in a public warning service announcement to at least one client node over a cellular broadcast channel. The processing circuitry is configured to cause the control node to transmit the public warning message on the MBMS bearer.

According to a third aspect there is presented a control node for providing a public warning message using MBMS in a wireless communications system. The control node comprises processing circuitry and a storage medium. The storage medium stores instructions that, when executed by the processing circuitry, cause the network node to perform operations, or steps. The operations, or steps, cause the network node to activate an MBMS bearer to be used for transmission of the public warning message. The operations, or steps, cause the network node to announce the MBMS bearer in a public warning service announcement to at least one client node over a cellular broadcast channel. The operations, or steps, cause the network node to transmit the public warning message on the MBMS bearer.

According to a fourth aspect there is presented a control node for providing a public warning message using MBMS in a wireless communications system. The control node comprises an activate module configured to activate an MBMS bearer to be used for transmission of the public warning message. The control node comprises an announce module configured to announce the MBMS bearer in a public warning service announcement to at least one client node over a cellular broadcast channel. The control node comprises a transmit module configured to transmit the public warning message on the MBMS bearer.

According to a fifth aspect there is presented a computer program for providing a public warning message using MBMS in a wireless communications system. The computer program comprises computer program code which, when run on processing circuitry of a control node, causes the control node to perform a method according to the first aspect.

According to a sixth aspect there is presented a method for obtaining a public warning message using MBMS in a wireless communications system. The method is performed by a client node. The method comprises obtaining a service announcement of an MBMS bearer in a public warning service announcement from a control node on a cellular broadcast channel. The method comprises obtaining the public warning message on the MBMS bearer.

According to a seventh aspect there is presented a client node for obtaining a public warning message using MBMS in a wireless communications system. The client node comprises processing circuitry. The processing circuitry is configured to cause the client node to obtain a service announcement of an MBMS bearer in a public warning service announcement from a control node on a cellular broadcast channel. The processing circuitry is configured to cause the client node to obtain the public warning message on the MBMS bearer.

According to an eighth aspect there is presented a client node for obtaining a public warning message using MBMS in a wireless communications system. The client node comprises processing circuitry and a storage medium. The storage medium stores instructions that, when executed by the processing circuitry, cause the client node to perform operations, or steps. The operations, or steps, cause the client node to obtain a service announcement of an MBMS bearer in a public warning service announcement from a control node on a cellular broadcast channel. The operations, or steps, cause the client node to obtain the public warning message on the MBMS bearer.

According to a ninth aspect there is presented a client node for obtaining a public warning message using MBMS in a wireless communications system. The client node comprises an obtain module configured to obtain a service announcement of an MBMS bearer in a public warning service announcement from a control node on a cellular broadcast channel. The client node comprises an obtain module configured to obtain the public warning message on the MBMS bearer.

According to a tenth aspect there is presented a computer program for obtaining a public warning message using MBMS in a wireless communications system. The computer program comprises computer program code which, when run on processing circuitry of a client node, causes the client node to perform a method according to the sixth aspect.

According to an eleventh aspect there is presented a method for obtaining a public warning message in a wireless communications system. The method is performed by a client node. The method comprises obtaining announcement of the public warning message from another client node.

According to a twelfth aspect there is presented a client node for method for obtaining a public warning message in a wireless communications system. The client node comprises processing circuitry. The processing circuitry is configured to cause the client node to obtain announcement of the public warning message from another client node.

According to a thirteenth aspect there is presented a client node for method for obtaining a public warning message in a wireless communications system. The client node comprises processing circuitry and a storage medium. The storage medium stores instructions that, when executed by the processing circuitry, cause the client node to obtain announcement of the public warning message from another client node.

According to a fourteenth aspect there is presented a client node for method for obtaining a public warning message in a wireless communications system. The client node comprises an obtain module configured to obtain announcement of the public warning message from another client node.

According to a fifteenth aspect there is presented a computer program for obtaining a public warning message in a wireless communications system, the computer program comprising computer program code which, when run on processing circuitry of a client node, causes the client node to perform a method according to the eleventh aspect.

According to a sixteenth aspect there is presented a computer program product comprising a computer program according to at least one of the fifth aspect, the tenth aspect, and the fifteenth aspect and a computer readable storage medium on which the computer program is stored. The computer readable storage medium can be a non-transitory computer readable storage medium.

Advantageously these methods, these control nodes, these client nodes, and these computer programs provide efficient distribution of public warning messages.

Advantageously these methods, these control nodes, these client nodes, and these computer programs enable public warning messages to be provided to a large number of users, regardless of network subscription, and eliminate the need for other communications channels (such as FM radio transmissions, and the Internet) to provide additional public warning information.

It is to be noted that any feature of the first, second, third, fourth, fifth, sixth seventh, eight, ninth, tenth, eleventh, twelfth, thirteen, fourteenth, fifteenth and sixteenth aspects may be applied to any other aspect, wherever appropriate. Likewise, any advantage of the first aspect may equally apply to the second, third, fourth, fifth, sixth, seventh, eight, ninth, tenth, eleventh twelfth, thirteen, fourteenth, fifteenth and sixteenth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2, 3, 4, 5, 6, and 7 are flowcharts of methods according to embodiments;

FIGS. 8, 9, and 10 are schematic illustrations of data structures according to embodiments;

FIG. 11 is a schematic diagram showing functional units of a control node according to an embodiment;

FIG. 12 is a schematic diagram showing functional modules of a control node according to an embodiment;

FIG. 13 is a schematic diagram showing functional units of a client node according to an embodiment;

FIG. 14 is a schematic diagram showing functional modules of a client node according to embodiments; and

FIG. 15 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

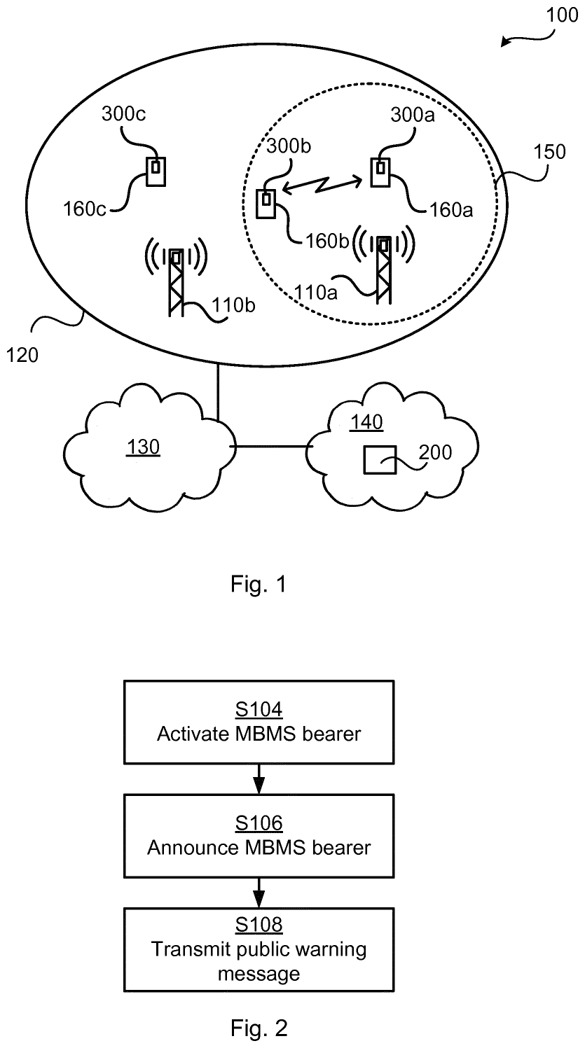

FIG. 1 is a schematic diagram illustrating a communications system 100 where embodiments presented herein can be applied. The communications system 100 may be regarded as a wireless communications system. The wireless communications system provides services to client nodes 300a, 300b, 300c. Each client node 300a, 300b, 300c may be provided in, or installed on, a respective wireless device 160a, 160b, 160c. In other words, a step, action, or similar that is performed by a client node 300a, 300b, 300c is, in some aspects, also performed by the wireless device 160a, 160b, 160c n which the client node 300a, 300b, 300c is provided.

The communications system 100 comprises a radio access network 120, a core network 130, and a service network 140. The communications system 100 further comprises at least one control node 200. The at least one control node 200 may be provided in, or installed on, a radio access network node 110 or in another entity or device in the radio access network 120, in an entity or device of the core network 130, or in an entity or device of the service network 140. The at least one control node 200 could implement the functionality of a public warning system server. The nodes indicated herein may be seen as functions, where each function may be implemented in one or more physical entities.

The radio access network 120 is operatively connected to the core network 130 which in turn is operatively connected to the service network 140. The radio access network node 110 thereby enables the wireless devices 160a, 160b, 160c, and hence the client nodes 300a, 300b, 300c in the wireless device respectively 160a, 160b, 160c, to access services and exchange data as provided by the service network 140. Particularly, the client nodes 300a, 300b, 300c are thereby enabled to communicate with the control node 200

Examples of wireless devices 160a, 160b, 160c include, but are not limited to, mobile stations, mobile phones, handsets, wireless local loop phones, user equipment (UE), smartphones, laptop computers, and tablet computers. Examples of radio access network nodes 110 include, but are not limited to, radio base stations, base transceiver stations, node Bs, evolved node Bs, and access points. As the skilled person understands, the communications system 100 may comprise a plurality of radio access network nodes 110, each providing network access to a plurality of wireless devices 160a, 160b, 160c. The herein disclosed embodiments are not limited to any particular number of radio access network nodes 110, client nodes 300a, 300b, 300c, or wireless devices 160a, 160b, 160c.

Multimedia Broadcast Multicast Service (MBMS), for example as specified in the technical specification 3GPP TS 23.246 v14.0.0 entitled “Multimedia Broadcast/Multicast Service (MBMS); Architecture and functional description”, can be used to efficiently transmit media content to a large number of users simultaneously. In general terms, MBMS is a unidirectional communication mechanism to broadcast any Internet Protocol (IP) based media. MBMS also provides several other mechanisms to schedule, announce services, perform error corrections and provide reception reporting.

MBMS could thus provide efficient transmission means for public warnings. To broadcast public warning messages to multiple client nodes 300a, 300b, 300c, or wireless devices 160a, 160b, 160c, MBMS services can thus be used. In the illustrative example of FIG. 1, an MBMS bearer could therefore be activated at least in a subset 150 of the wireless communications system 100. One concern is how to announce (i.e. inform) the client nodes 300a, 300b, 300c about the MBMS services carrying the public warning messages. Such announcement should be available to the client nodes 300a, 300b, 300c regardless of subscriptions and transmission capabilities of the hosting wireless device 160a, 160b, 160c.

The MBMS services announcement could be regarded as a required procedure to inform the client nodes 300a, 300b, 300c on when the broadcast is ongoing and how to receive the MBMS services in terms of network resources and the protocol/codec that is used.

Current mechanisms (see above referenced 3GPP TS 23.246 v14.0.0) provide different ways to perform MBMS services announcements. For example, via a Short Message Service (SMS) message or a Hypertext Transfer Protocol (HTTP) push message. The latter requires a unicast bearer to be established. Another way to do service announcement is to use a service discovery channel on an MBMS bearer that announces other MBMS services. The service announcement should typically include at least an identity of the MBMS bearer (known as the TMGI, Temporary Mobile Group Identifier), multicast IP address, ports, protocol and codecs used to receive the media over the MBMS bearer.

The herein disclosed embodiments provide mechanisms to perform MBMS services announcement over cell broadcast service. Furthermore, the announcement could be distributed to additional client nodes using a secondary announcement procedure.

The embodiments disclosed herein thus relate to mechanisms for providing a public warning message using MBMS in a wireless communications system 100. In order to obtain such mechanisms there is provided a control node 200, a method performed by the control node 200, a computer program product comprising code, for example in the form of a computer program, that when run on processing circuitry of the control node 200, causes the control node 200 to perform the method. In order to obtain such mechanisms there is further provided a client node 300a, a method performed by the client node 300a, and a computer program product comprising code, for example in the form of a computer program, that when run on processing circuitry of the client node 300a, causes the client node 300a to perform the method. In order to obtain such mechanisms there is further provided a client node 300b, a method performed by the client node 300b, and a computer program product comprising code, for example in the form of a computer program, that when run on processing circuitry of the client node 300b, causes the client node 300b to perform the method.

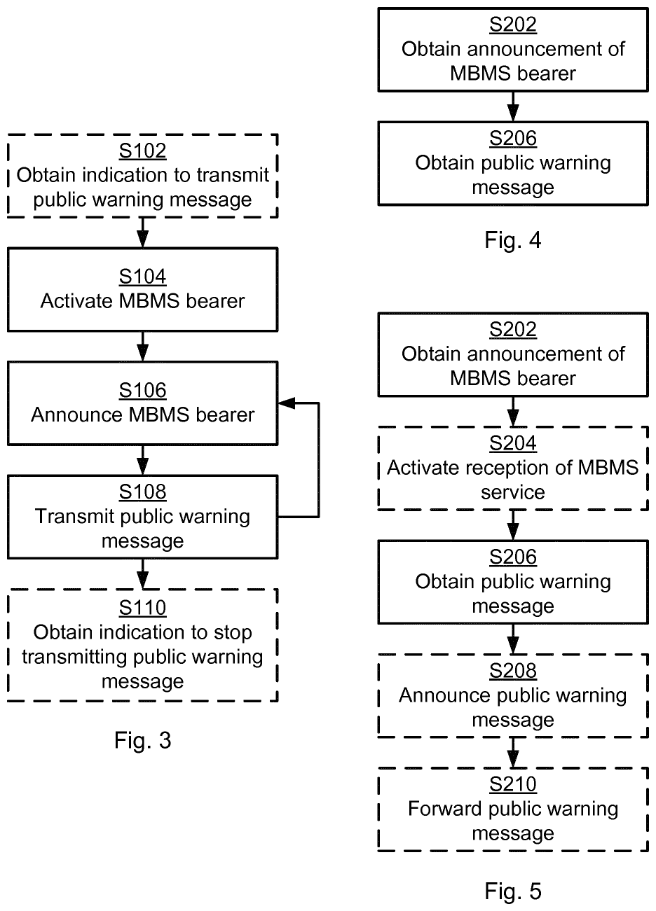

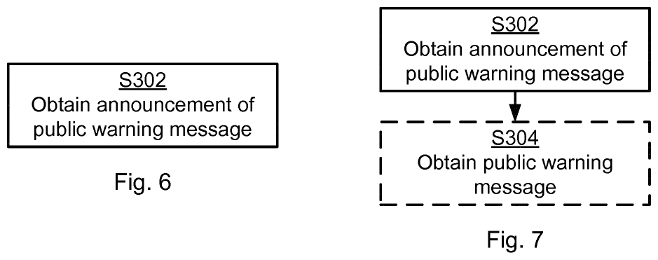

FIGS. 2 and 3 are flowcharts illustrating embodiments of methods for providing a public warning message using MBMS in a wireless communications system as performed by the control node 200. FIGS. 4 and 5 are flowcharts illustrating embodiments of methods for obtaining a public warning message using MBMS in a wireless communications system as performed by the client node 300a. FIGS. 6 and 7 are flowcharts illustrating embodiments of methods for obtaining a public warning message in a wireless communications system as performed by the client node 300b. The methods are advantageously provided as computer programs.

Reference is now made to FIG. 2 illustrating a method for providing a public warning message using MBMS in a wireless communications system 100 as performed by the control node 200 according to an embodiment.

Before transmitting a public warning message on an MBMS bearer the MBMS bearer needs to be activated. Hence, the control node 200 is configured to perform step S104:

S104: The control node 200 activates an MBMS bearer to be used for transmission of the public warning message.

When having been activated the MBMS bearer can be announced. Hence, the control node 200 is configured to perform step S106:

S106: The control node 200 announces the MBMS bearer in a public warning service announcement to at least one client node 300a over a cellular broadcast channel.

The public warning message can now be transmitted on the MBMS bearer. Hence, the control node 200 is configured to perform step S108:

S108: The control node 200 transmits the public warning message on the MBMS bearer.

A cell broadcast mechanism can thereby be used in order to notify all client nodes 300a in a geographically area about a public warning message. The message itself is carried over a MBMS bearer and can be received by all MBMS capable client nodes 300a, without any need for acknowledgment from the client nodes 300a.

When using an MBMS bearer for transmitting the public warning message the public warning message could be composed of a stream of data having a certain format. For example, the public warning message could be formatted so as to comprise a specification of the start of the public warning message, a specification of the end of message public warning message, and a specification any data formats of the included message components (e.g. text, audio, video). As an example, the public warning message could be provided in an extensible markup language (XML) format.

Embodiments relating to further details of providing a public warning message using MBMS in a wireless communications system 100 as performed by the control node 200 will now be disclosed.

Reference is now made to FIG. 3 illustrating methods for providing a public warning message using MBMS in a wireless communications system 100 as performed by the control node 200 according to further embodiments. It is assumed that steps S104, S106, S108 are performed as described above with reference to FIG. 2 and a thus repeated description thereof is therefore omitted.

In some aspects the control node 200 before announcing the MBMS bearer obtains an indication to start transmitting the public warning message. Hence, according to an embodiment the control node 200 is configured to perform step S102:

S102: The control node 200 obtains an indication to transmit the public warning message. The MBMS bearer is announced (as in step S106) and the public warning message is transmitted (as in step S108) in response thereto.

There may be different ways to activate the MBMS bearer as in step S104. One way to activate an MBMS bearer is disclosed in Section 8.3 of above referenced 3GPP TS 23.246 v14.0.0.

In some aspects the activation is based on geographical requirements of the public warning message. Particularly, according to an embodiment the MBMS bearer is activated in a subset 150 of the wireless communications system 100. The subset 150 is defined by a geographical area of interest associated with the public warning message. For example, if the public warning message pertains to an earthquake the MBMS bearer needs only to be activated in a subset 150 of the wireless communications system 100 surrounding the geographical area as affected by the earthquake, and so on. In order to accomplish this, a “Session start request” parameter that includes an “MBMS service area” value is taken into consideration when the MBMS bearer is activated. The “MBMS service area” value can thus be selected such that the MBMS bearer is activated only in a subset 150 of the wireless communications system 100.

In some embodiments the MBMS bearer is repeatedly announced (by the control node 200 repeating step S106) and the public warning message is repeatedly transmitted (by the control node repeating step S108). That is, the control node 200 could be configured to alternatingly or in parallel perform steps S106 and S108. Hence, one announcement occurrence can be followed by a transmission occurrence, followed by another announcement occurrence, and so on.

The announcement and the transmission could be performed until an event occurs that causes the public warning message to be ceased. Hence, according to an embodiment the control node 200 is configured to perform step S110:

S110: The control node 200 obtains an indication to stop transmitting the public warning message. The MBMS bearer is then repeatedly announced and the public warning message is repeatedly transmitted until the indication in step S110 is obtained. The control node 200 could then further be configured to deactivate the MBMS bearer.

The indication in step S110 could be obtained from the same entity as the indication in step S102 is obtained. Alternatively, the indication in step S110 and the indication in step S102 are obtained from different entities. Examples of entities from which the indications in step S102 and S110 could be obtained are surveillance centers and emergency centers.

Reference is now made to FIG. 4 illustrating a method for obtaining a public warning message using MBMS in a wireless communications system 100 as performed by the client node 300a according to an embodiment.

As disclosed above, the control node 200 in step S106 announces the MBMS bearer in a public warning service announcement. It is assumed that the client node 300a obtains this announcement. Hence, the client node 300a is configured to perform step S202:

S202: The client node 300a obtains a service announcement of an MBMS bearer in a public warning service announcement from the control node 200 on a cellular broadcast channel.

As disclosed above, the control node 200 in step S108 transmits the public warning message on the MBMS bearer. It is assumed that the client node 300a obtains this public warning message. Hence, the client node 300a is configured to perform step S206:

S206: The client node 300a obtains the public warning message on the MBMS bearer.

Embodiments relating to further details of obtaining a public warning message using MBMS in a wireless communications system 100 as performed by the client node 300a will now be disclosed.

Reference is now made to FIG. 5 illustrating methods for obtaining a public warning message using MBMS in a wireless communications system 100 as performed by the client node 300a according to further embodiments. It is assumed that steps S202, S206 are performed as described above with reference to FIG. 4 and a thus repeated description thereof is therefore omitted.

As disclosed above, the client node 300a in step S204 activates, e.g. in response to receiving the announcement in step S202, the MBMS bearer to be used for transmission of the public warning message. Similarly, in some aspects the client node 300a activates reception of an MBMS service on the MBMS bearer when having obtained the service announcement of the MBMS bearer in step S202. Hence, according to an embodiment the client node 300a is configured to perform step S204:

S204: The client node 300a activates reception of an MBMS service on the MBMS bearer in response to having obtained the service announcement of the MBMS bearer.

There may be different actions for the client node 300a to take once having obtained the public warning message on the MBMS bearer in step S206. In some aspects the client node 300a makes a secondary announcement of the public warning message for other client nodes 300b. Hence, according to an embodiment the client node 300a is configured to perform step S208:

S208: The client node 300a announces the public warning message to another client node 300b. This so-called another client node 300b could be assumed not to support MBMS or be at least temporarily out of coverage of receiving the transmission on the MBMS bearer.

There could be different ways for the client node 300a to announce the public warning message to the so-called another client node 300b. Examples include, but are not limited to, non-cellular wireless communication technologies, ProSe (for example as specified in the technical specification 3GPP TS 23.303 v14.1.0 entitled “Proximity-based services (ProSe); Stage 2”), Bluetooth, or WiFi. For example, the client node 300a could be configured to use a ProSe UE-to-Network relay mechanism to reach client nodes that are out of coverage but in close proximity to the client node 300a itself.

Once the public warning message has been announced to the other client node 300b it could be forwarded by the client node 300a to the client node 300b. Hence, according to an embodiment the client node 300a is configured to perform step S210:

S210: The client node 300a forwards the public warning message to the so-called another client node 300b.

In some aspects the public warning message comprises an indication that the client node 300a is to forward the public warning message to other client nodes, e.g. client node 300b. In other aspects the client node 300a forwards the public warning message without the public warning message needing to comprise such an indication.

There could be different ways for the client node 300a to forward the public warning message to the so-called another client node 300b. In some examples the public warning message is forwarded using the same technology as the public warning message is announced. In other examples the public warning message is forwarded using another technology than for announcing the public warning message.

Reference is now made to FIG. 6 illustrating a method for obtaining a public warning message in a wireless communications system 100 as performed by the so-called another client node 300b according to an embodiment. The client node 300b could be assumed not to support MBMS or at least temporarily be out of coverage of receiving the transmission on the MBMS bearer.

As disclosed above, in some embodiments the client node 300a in a step S208 announces the public warning message to another client node 300b. It is here assumed that this announcement is obtained by the client node 300b. Hence, the client node 300b is configured to perform step S302:

S302: The client node 300b obtains announcement of the public warning message from another client node 300a.

Embodiments relating to further details of obtaining a public warning message in a wireless communications system 100 as performed by the so-called another client node 300b will now be disclosed.

Reference is now made to FIG. 7 illustrating methods for obtaining a public warning message in a wireless communications system 100 as performed by the so-called another client node 300b according to further embodiments. It is assumed that step S302 is performed as described above with reference to FIG. 6 and a thus repeated description thereof is therefore omitted.

There may be different ways for the client node 300b to obtain the actual public warning message once the client node 300b as obtained the announcement in step S302. For example, the public warning message could be obtained either from the client node 300a announcing the public warning message or from another entity. Particularly, according to an embodiment the client node 300b is configured to perform step S304:

S304: The client node 300b obtains the public warning message either from the so-called another client node 300a or from another entity in the wireless communications system 100.

Further aspects and embodiments applicable to the above disclosed methods performed by the control node 200 and the client node 300a, 300b will now be disclosed.

There could be different types of cellular broadcast channels on which the MBMS bearer is announced in step S106 and on which the service announcement of the MBMS bearer is obtained in step S202. According to an embodiment the cellular broadcast channel is a broadcast control channel (BCCH).

There could be different ways for the MBMS bearer to be announced. According to an embodiment the MBMS bearer is announced in a system information block (SIB) of the cellular broadcast channel. For example, in a Long Term evolution (LTE) network the MBMS service announcement can be announced in a SIB by extending SIB11. Hence, according to an embodiment the MBMS bearer is announced in SIB11.

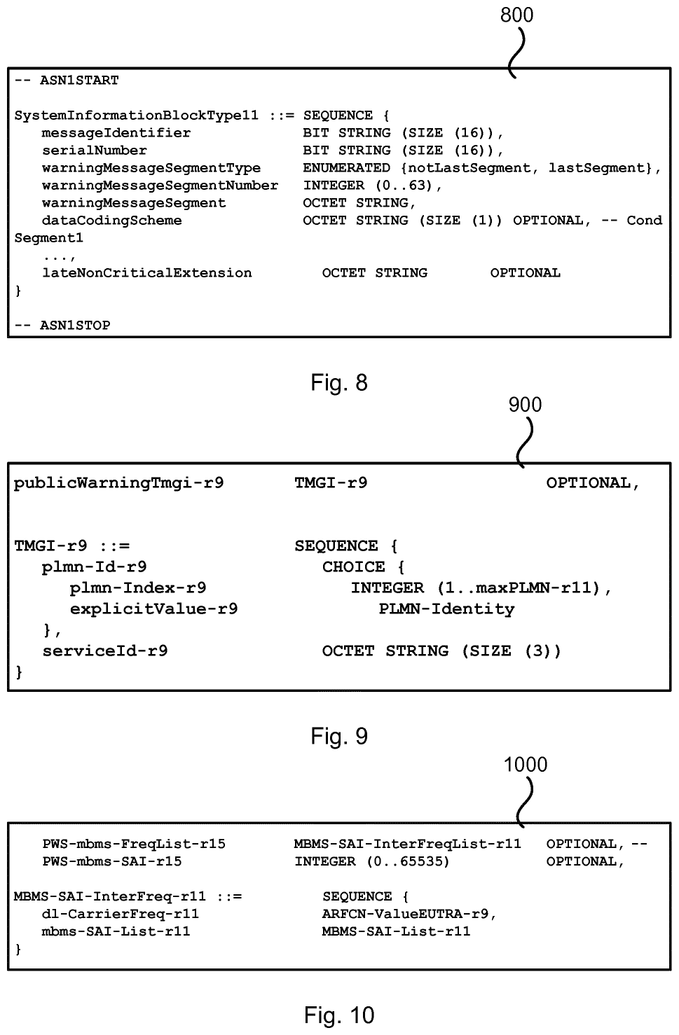

FIG. 8 illustrates an examples data structure 800 of SIB11 as given in the technical specification 3GPP TS 36.331 v14.0.0 entitled “Evolved Universal Terrestrial Radio Access (E-UTRA); Radio Resource Control (RRC); Protocol specification”.

FIG. 9 illustrates an examples data structure 900 representing an extension of SIB11 in FIG. 8. The data structure 900 would enable service announcements for public warning messages to be made using MBMS bearers. As illustrated in FIG. 9 the data structure 900 comprises a publicWarningTmgi-r9, parameter. Hence, according to an embodiment SIB11 comprises a temporary mobile group identifier release 9 (publicWarningTmgi-r9) parameter.

In some aspects SIB11 is extended to comprise other information such as multicast Internet Protocol (IP) address, port number, protocol, and codec for media in the public warning message. Hence, according to an embodiment SIB11 comprises at least one of multicast IP address, identification of port number, identification of protocol, and identification of codec for receiving and encoding content on the MBMS bearer of the public warning message.

Alternatively, the multicast IP address, identification of port number, identification of protocol, and identification of codec for receiving and encoding content on the MBMS bearer of the public warning message is provided to the client node 300 using other means than in SIB 11. Example of such provisioning is utilizing standardized values native in the wireless device 160a hosting the client node 300a, or being pushed out (e.g. by SMS) from a mobile network operator, or utilizing a standardized mechanism for user service announcement over MBMS bearer as defined in the technical specification 3GPP TS 26.346 v. 14.1.0 entitled “Multimedia Broadcast/Multicast Service (MBMS); Protocols and codecs”.

In some aspects the public warning message should reach client nodes of wireless devices (in the geographical area of interest) that have network subscriptions to mobile network operators that are temporarily out of service when the MBMS bearer is announced (step S106) and the public warning message is transmitted (step S108). In some aspects the public warning message should reach client nodes of wireless devices (in the geographical area of interest) that are out of coverage of its home mobile network and where there is not any roaming agreement in place between the home mobile network operator of the wireless devices and the mobile network operator of the mobile network serving the geographical area in which the wireless devices are located. SIB11 could therefore comprise a parameter as illustrated in FIG. 10. FIG. 10 illustrates a data structure 100 representing an extension of SIB11 in FIG. 8. Hence, according to an embodiment SIB11 comprises at least one of a PWS-mbms-FreqList-r15 parameter and a PWS-mbms-SAI-r15 parameter. The parameters are optional and may indicate the frequency band, in which the MBMS bearer is activated, and optionally also the service area identifier (SAI) used for the MBMS bearer. This enables the public warning message to reach the aforementioned client nodes.

Further, wireless devices that do not have a network subscription to the mobile network operator of the mobile network serving the geographical area in which the wireless devices are located will only receive and be able to decode SIB1 in order to obtain the mobile network identity (PLMN ID), and thereafter these wireless devices will decide to neither to receive any other information from the mobile network nor to try to access the mobile network. For the public warning message to reach client nodes of such wireless devices an indication can be added in SIB1 that there is an ongoing public warning message being transmitted. Hence, according to an embodiment the public warning message is announced in SIB1. This could trigger such wireless devices to also listen to SIB10 and SIB11, and further find the correct MBMS bearer.

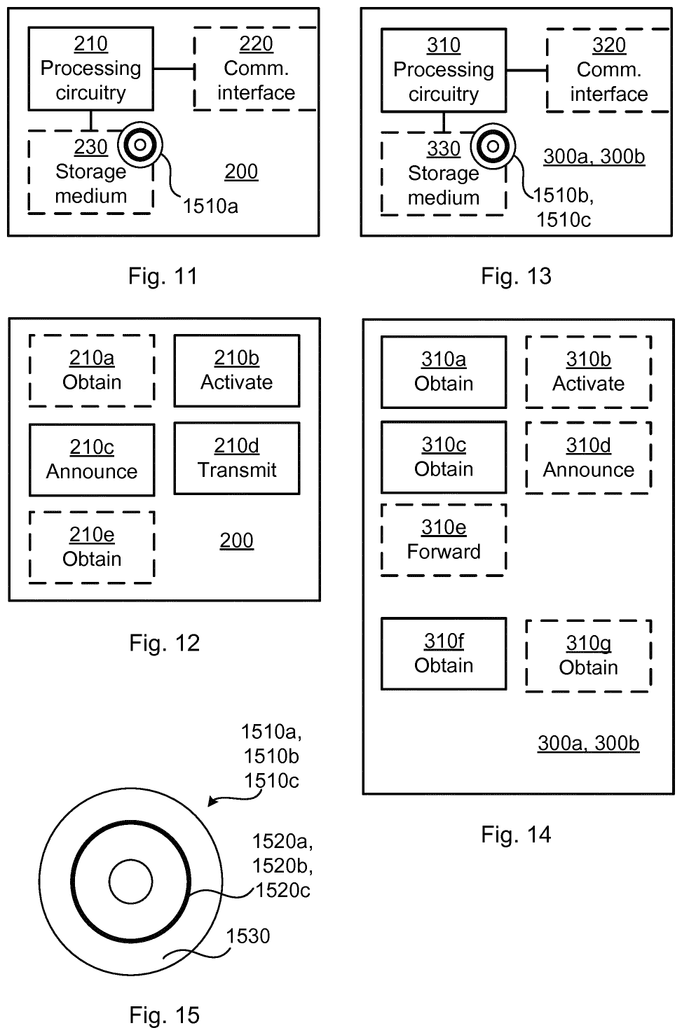

FIG. 11 schematically illustrates, in terms of a number of functional units, the components of a control node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1510a (as in FIG. 15), e.g. in the form of a storage medium 230. The processing circuitry 210 may further be provided as at least one application specific integrated circuit (ASIC), or field programmable gate array (FPGA).

Particularly, the processing circuitry 210 is configured to cause the control node 200 to perform a set of operations, or steps, S102-S110, as disclosed above. For example, the storage medium 230 may store the set of operations, and the processing circuitry 210 may be configured to retrieve the set of operations from the storage medium 230 to cause the control node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The control node 200 may further comprise a communications interface 220 for communications with other entities, nodes, and devices, of the communications network 100, such as at least one client node 300a, 300b. As such the communications interface 220 may comprise one or more transmitters and receivers, comprising analogue and digital components.

The processing circuitry 210 controls the general operation of the control node 200 e.g. by sending data and control signals to the communications interface 220 and the storage medium 230, by receiving data and reports from the communications interface 220, and by retrieving data and instructions from the storage medium 230. Other components, as well as the related functionality, of the control node 200 are omitted in order not to obscure the concepts presented herein.

FIG. 12 schematically illustrates, in terms of a number of functional modules, the components of a control node 200 according to an embodiment. The control node 200 of FIG. 12 comprises a number of functional modules; an activate module 210b configured to perform step S104, an announce module 210c configured to perform step S106, and a transmit module 210d configured to perform step S108. The control node 200 of FIG. 12 may further comprise a number of optional functional modules, such as any of an obtain module 210a configured to perform step S102 and an obtain module 210e configured to perform step S110. In general terms, each functional module 210a-210e may be implemented in hardware or in software. Preferably, one or more or all functional modules 210a-210e may be implemented by the processing circuitry 210, possibly in cooperation with the communications interface 220 and the storage medium 230. The processing circuitry 210 may thus be arranged to from the storage medium 230 fetch instructions as provided by a functional module 210a-210e and to execute these instructions, thereby performing any steps of the control node 200 as disclosed herein.

The control node 200 may be provided as a standalone device or as a part of at least one further device. For example, the control node 200 may be provided in a node of the radio access network 120 or in a node of the core network 130 or in a node of the service network 140. Alternatively, functionality of the control node 200 may be distributed between at least two devices, or nodes. These at least two nodes, or devices, may either be part of the same network part (such as the radio access network or the core network or the service network) or may be spread between at least two such network parts. Some examples of where in the communications system 100 the control node 200 may be provided are illustrated in FIG. 1.

Functionality of the control node 200 may be implemented at the service layer of the protocol stack. In general terms, instructions that are required to be performed in real time may be performed in a device, or node, operatively closer to the radio access network 120 than instructions that are not required to be performed in real time. In this respect, at least part of the control node 200 may reside in the radio access network 120, such as in the radio access network node 110, for cases when embodiments as disclosed herein are performed in real time.

Thus, a first portion of the instructions performed by the control node 200 may be executed in a first device, and a second portion of the of the instructions performed by the control node 200 may be executed in a second device; the herein disclosed embodiments are not limited to any particular number of devices on which the instructions performed by the control node 200 may be executed. Hence, the methods according to the herein disclosed embodiments are suitable to be performed by a control node 200 residing in a cloud computational environment. Therefore, although a single processing circuitry 210 is illustrated in FIG. 11 the processing circuitry 210 may be distributed among a plurality of devices, or nodes. The same applies to the functional modules 210a-210e of FIG. 12 and the computer program 1520a of FIG. 15 (see below).

FIG. 13 schematically illustrates, in terms of a number of functional units, the components of a client node 300a, 300b according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1510b (as in FIG. 15), e.g. in the form of a storage medium 330. The processing circuitry 310 may further be provided as at least one application specific integrated circuit (ASIC), or field programmable gate array (FPGA).

Particularly, the processing circuitry 310 is configured to cause the client node 300a, 300b to perform a set of operations, or steps, S202-S210, S302-S304, as disclosed above. For example, the storage medium 330 may store the set of operations, and the processing circuitry 310 may be configured to retrieve the set of operations from the storage medium 330 to cause the client node 300a, 300b to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The client node 300a, 300b may further comprise a communications interface 320 for communications with other entities, nodes, and devices, of the communications network 100, such as the control node 200 and at least one other client node 300a, 300b. As such the communications interface 320 may comprise one or more transmitters and receivers, comprising analogue and digital components.

The processing circuitry 310 controls the general operation of the client node 300a, 300b e.g. by sending data and control signals to the communications interface 320 and the storage medium 330, by receiving data and reports from the communications interface 320, and by retrieving data and instructions from the storage medium 330. Other components, as well as the related functionality, of the client node 300a, 300b are omitted in order not to obscure the concepts presented herein.

FIG. 14 schematically illustrates, in terms of a number of functional modules, the components of a client node 300a, 300b according to an embodiment. The client node 300a of FIG. 14 comprises an obtain module 310a configured to perform step S202 and an obtain module 310c configured to perform step S206. The client node 300a of FIG. 14 may further comprise a number of optional functional modules, such as any of an activate module 310b configured to perform step S204, an announce module 310d configured to perform step S208, and a forward module 310e configured to perform step S210.

The client node 300b of FIG. 14 comprises an obtain module 310f configured to perform step S302. The client node 300b of FIG. 14 may further comprise a number of optional functional modules, such as an obtain module 310g configured to perform step S304.

In general terms, each functional module 310a-310g may be implemented in hardware or in software. Preferably, one or more or all functional modules 310a-310g may be implemented by the processing circuitry 310, possibly in cooperation with the communications interface 320 and the storage medium 330. The processing circuitry 310 may thus be arranged to from the storage medium 330 fetch instructions as provided by a functional module 310a-310g and to execute these instructions, thereby performing any steps of the client node 300a, 300b as disclosed herein.

The client node 300a, 300b may be provided as a standalone device or as a part of at least one further device. For example, the client node 300a, 300b may be provided in a wireless device 160a, 160b.

FIG. 15 shows one example of a computer program product 1510a, 1510b, 1510c comprising computer readable means 1530. On this computer readable means 1530, a computer program 1520a can be stored, which computer program 1520a can cause the processing circuitry 210 and thereto operatively coupled entities and devices, such as the communications interface 220 and the storage medium 230, to execute methods according to embodiments described herein. The computer program 1520a and/or computer program product 1510a may thus provide means for performing any steps of the control node 200 as herein disclosed. On this computer readable means 1530, a computer program 1520b can be stored, which computer program 1520b can cause the processing circuitry 310 and thereto operatively coupled entities and devices, such as the communications interface 320 and the storage medium 330, to execute methods according to embodiments described herein. The computer program 1520b and/or computer program product 1510b may thus provide means for performing any steps of the client node 300a as herein disclosed. On this computer readable means 1530, a computer program 1520c can be stored, which computer program 15200c can cause the processing circuitry 310 and thereto operatively coupled entities and devices, such as the communications interface 320 and the storage medium 330, to execute methods according to embodiments described herein. The computer program 1520c and/or computer program product 1510c may thus provide means for performing any steps of the client node 300b as herein disclosed.

In the example of FIG. 15, the computer program product 1510a, 15100b, 1510c is illustrated as an optical disc, such as a CD (compact disc) or a DVD (digital versatile disc) or a Blu-Ray disc. The computer program product 1510a, 15100b, 1510c could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1520a, 1520b, 1520c is here schematically shown as a track on the depicted optical disk, the computer program 1520a, 1520b, 1520c can be stored in any way which is suitable for the computer program product 1510a, 15100b, 1510c.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for providing a public warning message using a multimedia broadcast multicast service, MBMS, in a wireless communications system, the method being performed by a control node, the method comprising:
activating an MBMS bearer to be used for transmission of the public warning message;
announcing the MBMS bearer in a public warning service announcement to at least one client node over a cellular broadcast channel; and
transmitting the public warning message on the MBMS bearer.

2. The method according to claim 1, further comprising:
obtaining an indication to transmit the public warning message, and wherein the MBMS bearer is announced and the public warning message is transmitted in response thereto.

3. The method according to claim 1, wherein the MBMS bearer is repeatedly announced and the public warning message is repeatedly transmitted.

4. The method according to claim 1, further comprising:
obtaining an indication to stop transmitting the public warning message, and wherein the MBMS bearer is repeatedly announced and the public warning message is repeatedly transmitted until the indication is obtained.

5. The method according to claim 1, wherein the MBMS bearer is activated in a subset of the wireless communications system, and wherein the subset is defined by a geographical area of interest associated with the public warning message.

6. A method for obtaining a public warning message using a multimedia broadcast multicast service, MBMS, in a wireless communications system, the method being performed by a client node, the method comprising:
obtaining a service announcement of an MBMS bearer in a public warning service announcement from a control node on a cellular broadcast channel; and
obtaining the public warning message on the MBMS bearer.

7. The method according to claim 6, further comprising:
activating reception of an MBMS service of the MBMS bearer in response to having obtained the service announcement of the MBMS bearer.

8. The method according to claim 6, further comprising:
announcing the public warning message to another client node.

9. The method according to claim 8, further comprising:
forwarding the public warning message to said another client node.

10. The method according to claim 1, wherein the cellular broadcast channel is a broadcast control channel, BCCH.

11. The method according to claim 1, wherein the MBMS bearer is announced in a system information block, SIB, of the cellular broadcast channel.

12. The method according to claim 11, wherein the MBMS bearer is announced in SIB11.

13. The method according to claim 12, wherein said SIB 11 comprises a public warning temporary mobile group identifier release 9, publicWarningTmgi-r9, parameter.

14. The method according to claim 12, wherein said SIB 11 comprises at least one of multicast IP address, identification of port number, identification of protocol, and identification of codec for receiving and encoding content on the MBMS bearer of the public warning message.

15. The method according to claim 12, wherein said SIB 11 comprises at least one of a PWS-mbms-FreqList-r15 parameter and a PWS-mbms-SAI-r15 parameter.

16. The method according to claim 11, wherein the public warning message is announced in SIB 1.

17. A method for obtaining a public warning message in a wireless communications system, the method being performed by a client node, the method comprising:
obtaining announcement of the public warning message from another client node.

18. The method according to claim 17, further comprising:
obtaining the public warning message either from said another client node or from another entity in the wireless communications system.

19. (canceled)

20. A control node for providing a public warning message using a multimedia broadcast multicast service, MBMS, in a wireless communications system, the control node comprising:
processing circuitry; and
a storage medium storing instructions that, when executed by the processing circuitry, cause the control node to:
activate an MBMS bearer to be used for transmission of the public warning message;
announce the MBMS bearer in a public warning service announcement to at least one client node over a cellular broadcast channel; and
transmit the public warning message on the MBMS bearer.

21. (canceled)

22. (canceled)

23. A client node for obtaining a public warning message using a multimedia broadcast multicast service, MBMS, in a wireless communications system, the client node comprising:
processing circuitry; and
a storage medium storing instructions that, when executed by the processing circuitry, cause the client node to:
obtain a service announcement of an MBMS bearer in a public warning service announcement from a control node on a cellular broadcast channel; and
obtain the public warning message on the MBMS bearer.

24. (canceled)

25. (canceled)

26. A client node for method for obtaining a public warning message in a wireless communications system, the client node comprising:
processing circuitry; and
a storage medium storing instructions that, when executed by the processing circuitry, cause the client node to:
obtain announcement of the public warning message from another client node.

27. (canceled)

28. A computer program for providing a public warning message using a multimedia broadcast multicast service, MBMS, in a wireless communications system, the computer program comprising computer code which, when run on processing circuitry of a control node, causes the control node to:
activate an MBMS bearer to be used for transmission of the public warning message;
announce the MBMS bearer in a public warning service announcement to at least one client node over a cellular broadcast channel; and
transmit the public warning message on the MBMS bearer.

29. A computer program for obtaining a public warning message using a multimedia broadcast multicast service, MBMS, in a wireless communications system, the computer program comprising computer code which, when run on processing circuitry of a client node, causes the client node to:
obtain a service announcement of an MBMS bearer in a public warning service announcement from a control node on a cellular broadcast channel; and
obtain the public warning message on the MBMS bearer.

30. A computer program for method for obtaining a public warning message in a wireless communications system, the computer program comprising computer code which, when run on processing circuitry of a client node, causes the client node to:
obtain announcement of the public warning message from another client node.

31. (canceled)
